(19) United States
(12) Patent Application Publication
(10) Pub. No.: US 2026/0307841 A1
(43) Pub. Date: Oct. 8, 2026

(54) SYSTEM AND METHOD FOR MANUFACTURING A COMPOSTABLE POD FOR BEVERAGE PREPARATION FROM A PAPER-BASED MATERIAL

(71) Applicant: SOCIÉTÉ DES PRODUITS NESTLÉ S.A., Vevey (CH)

(72) Inventors: Nicola GALAFFU, Ornex (FR); Karim MISSOUM, Pusignan (FR); Gerhard NIEDERREITER, Vevey (CH)

(21) Appl. No.: 19/100,710

(22) PCT Filed: Aug. 8, 2023
(86) PCT No.: PCT/EP2023/071880

§ 371 Date: Feb. 3, 2025

(30) Foreign Application Priority Data
Aug. 12, 2022 (EP) 22190143.2

(51) Int. Cl. B65B 29/02; B65B 9/04; B65B 41/12

(52) U.S. Cl. CPC B65B 29/025; B65B 9/04; B65B 41/12

(57) ABSTRACT

The invention relates to a system (100) for manufacturing a compostable pod (900) for brewing products. Therein, the pod (900) is made from a sheet (600) made of a biodegradable cellulose-based material. The system (100) comprises at least one shaping line (200), which comprises a handling unit (300) for transferring the sheet (600) along a transfer direction (TD) through the system (100). The shaping line (200) further comprises a humidifying unit (400) for moistening at least one side of the sheet (600) with a moistening agent (401), and a forming unit (800) for shaping a part of the moistened sheet (600) into a three-dimensional shape to form a pod element (910), which defines a pod cavity (911). The part (642) is located between opposite, with respect to the transfer direction (TD), lateral side edge sections (631, 632) of the sheet (600). The shaping line (200) comprises further a lateral drying unit (500) arranged to dry the opposite lateral side edge sections (631, 632) of the moistened sheet (641), while keeping at least the part (642) to be shaped moistened. Therein, the lateral drying unit (500) is arranged downstream of the humidifying unit (400) and upstream of the forming unit (800). The invention also relates to a method for manufacturing a compostable pod (900), wherein, before shaping the part (642) of the moistened sheet (641), said opposite lateral side edge sections (631, 632) of the moistened sheet (641) are dried while at least the part (642) to be shaped is kept moistened.

### 1. FIELD OF THE INVENTION

The present invention relates to a system and method for manufacturing a compostable pod for brewing products, wherein the pod is manufactured from a sheet made of a biodegradable cellulose-based material.

### 2. TECHNICAL BACKGROUND

Single-serve beverage containers for beverage preparation machines, such as capsules or pods, are known in the art. These beverage containers are commonly used for on demand dispensing of beverages, like coffee, tea or hot chocolate, and enjoy popularity due to fresh tasting, variability of flavours and convenience of the beverage preparation.

Typically, these known beverage containers are made of materials, for which reusing, recycling or composting is challenging, particularly after use of the beverage container. Therefore, efforts are made to replace these established materials with biodegradable or compostable materials, such as cellulose-based materials, like paper, for which the process of disposing used beverage containers is less challenging (e.g. via composting).

The use of new materials for the beverage containers requires also new manufacturing processes. For instance, in industrial production, a beverage container made from cellulose-based material may be produced from an endless (continuous) sheet of a paper material that travels through different stations of a production line. At one station, a section of the sheet is formed into a half-shell and subsequently filled with a beverage component, such as coffee, before being sealed closed with another half-shell or lid.

Therein, it was found that moistening the sheet before forming the half-shell can be beneficial for the structural integrity and shelf-life of the resulting beverage container because the half-shells may tear or split due to mechanical stress during the forming process. These effects can be avoided or even eliminated by moistening the sheet before undertaking the forming step. An example for a manufacturing process implementing such moistening process can be found in WO 2020/031096 A1.

In the moistening process, water is applied to the entire surface of the sheet to ensure a homogeneous moisture distribution. A disadvantage of such treatment is that sections of the sheet, which will not undergo form shaping, are wetted also and thus, are exposed to the liquid. This, however, may lead to the undesired side-effect of sheet curling. For example, cellulose-based sheet materials typically comprise hollow fibres that absorb water, leading to an expansion of the fibres in diameter but not length. As a consequence, mechanical tension builds up inside the sheet material, which may cause the sheet to curl or wrinkle. This effect may be aggravated even further in case the sheet material has a directional composition, i.e. most fibres of the sheet material are aligned and directed along a particular direction. Moreover, the sheet materials used for beverage containers typically comprise multiple layers, such as barrier layers. Each layer may react (e.g. expand) differently when coming into contact with water resulting in the sheet curling.

Unfortunately, the effects of curling are difficult to reverse in cellulose-based sheet materials. In particular, subjecting the sheet to water may cause the fibres to arrange differently or may release material inherent tensions, which, after drying the sheet, may return and lead to curling of the (originally flat) sheet.

This material behaviour can be problematic in the manufacturing process of a beverage container:

For instance, sections of the beverage container, which are designated for being connected with a closing element for closing and sealing the (then dried and filled) beverage container, typically do not undergo form shaping and thus, are prone to be affected by curling due to a lack of structural support during the manufacturing process. This, however, may compromise the connection between the closing element and the beverage container since curls may lead to insufficient contact, gaps and channels into the beverage container interior. Consequently, the integrity and quality of the beverage container cannot be ensured in such process, thereby limiting the shelf-life of the product inside the beverage containers.

In addition, transporting and handling the sheet material in the manufacturing process becomes more difficult because mechanical properties, such as tensile strength or tear resistance, are reduced for a moistened sheet in comparison to a dry sheet. Thus, dragging or pushing the sheet through a manufacturing line becomes more challenging.

In the prior art, the above described problems were addressed by fixing the sheet material in a solid frame and letting the same slowly dry over time. Unfortunately, this known solution cannot be applied to industrial manufacturing of beverage containers, where continuous processing is preferred to allow for high cycle rates.

Thus, it is an object of the invention to provide a system and a method for manufacturing a pod made from a compostable material, by which the structural integrity and shelf-life of the produced pod can be improved and ensured. Therein, it is a particular object of the invention to reduce or eliminate the risk of curling of the sheet material, particularly at sections that do not undergo form shaping. Moreover, it is an object of the invention to reduce or even eliminate the risk of the sheet tearing in the manufacturing process.

These and other objects, which become apparent upon reading the description, are solved by the subject-matter of the independent claims. The dependent claims refer to preferred embodiments of the invention.

### SUMMARY OF THE INVENTION

A first aspect of the invention relates to a system for manufacturing a compostable pod for brewing products. The system is (configured/suitable) for manufacturing the pod from a sheet, which is made of a biodegradable cellulose-based material.

Therein, the term “pod” may be understood, for example, as any (closed) container for preparing a beverage in a beverage production machine (e.g. a capsule). A beverage preparation may comprise solving, brewing or percolating a substance enclosed inside the pod to produce a brewing product, such as coffee, tea, fruit infusion or culinary bouillons, for instance.

The term “sheet” may be understood, for example, as a large, thin, flat, piece of material. For example, the sheet may be a paper-based sheet material that is supplied in a dry state, i.e. having a maximum level of (relative) moisture or humidity in the range from 2% to 8%, preferably 5%. However, the level of (relative) moisture or humidity depends on the environmental conditions.

Moreover, the term “compostable” may be understood as meaning that a material may be substantially broken down into organic matter (mainly water, CO2 (or methane) and biomass) within a few weeks or months when it is composted. This may be accomplished in industrial composting sites and/or home composters. Specific conditions relating to temperature, relative humidity may exist at such sites. Additional conditions may also influence the composting such like wind, sunlight, drainage and other factors. At the end of a composting process, the earth may be supplied with nutrients once the material has completely broken down. International standards, such as EU 13432 or US ASTM D6400, provide a legal framework for specifying technical requirements and procedures for determining compostability of a material. In comparison, a “biodegradable” material may be understood as any material that can be broken down into environmentally innocuous products by (the action of) living things (such as microorganisms, e.g. bacteria, fungi or algae). This process can take place in an environment with or without the presence of oxygen (aerobic/anaerobic).

The system comprises at least one shaping line.

Therein, the expression “shaping line”, may be understood, for example, as a system or arrangement capable of (sequentially) performing various functions or operations involved within the pod production (manufacturing) process, which preferably may be interlinked (to produce a compostable pod with reliable and high structural integrity).

The shaping line comprises a handling unit for transferring the sheet along a transfer direction through the system. The shaping line further comprises a humidifying unit for moistening at least one side of the sheet with a moistening agent.

Therein, the expression “humidifying unit” may be understood, for example, as a component of the shaping line capable (or configured) for bringing (applying, or introducing) a moistening agent (a liquid, gas, solution) into or onto the sheet. For this, the moistening agent may be applied directly onto the sheet, or by the humidifying unit making a carrier medium (e.g. ambient air) humid or damp that can transfer moisture onto the sheet. The “moistening agent” may be, for example, any substance or liquid, such as water or any aqueous solution, which preferably may be suitable for reducing the sheet material inherent rigidity of the pod for the shaping step.

The shaping line further comprises a forming unit for shaping a part of the moistened sheet into a three-dimensional shape to form a pod element defining a pod cavity.

Therein, the term “shaping” may be understood, for example, as using the characteristic of a material being formable, malleable, and/or pliable to change its (three-dimensional) shape (with or without the support of additional tools, and/or preferably with or without the application of heat). Further, the term “moistened” may be understood, for example, as the sheet material being subjected to (and the sheet material preferably carrying an amount of) the moistening agent and the moistening agent being present in the material.

Along the present application the terms “moistened” and “humidified” may be interchanged as well as the terms “moistening” and “humidifying”.

The said part of the sheet is located between opposite, with respect to the transfer direction, lateral side edge sections of the sheet.

Therein, the expression “lateral side edge section” may be understood, for example, as an area, portion or part of the sheet, which, for instance, may extend longitudinally with the (lateral) side edges of the sheet and/or may extend laterally towards the respective opposite side edge of the sheet.

The at least one shaping line further comprises a lateral drying unit, which is arranged downstream of the humidifying unit and upstream of the forming unit. The lateral drying unit is arranged (configured) to dry the opposite lateral side edge sections of the moistened sheet, while keeping at least the part to be shaped moistened.

Therein, the expression “drying unit” may be understood, for example, as a device or station for reducing or removing the (liquid or gaseous) content of a (foreign) substance contained inside or on a surface of the sheet material, preferably by evaporation and/or by supplying energy for evaporation of the substance(s).

In other words: According to the invention, a manufacturing system can be provided that is capable of producing a compostable pod from a cellulose-based sheet material.

For this, a handling unit is provided, by which the sheet can be (linearly) transferred (transported, moved, dragged, conveyed) through the system. Further, a humidifying unit is provided, by which a (liquid and/or gaseous) moistening agent can be applied (homogeneously) onto at least one side of the sheet. A drying unit is provided, by which sections of the moistened sheet, which will not be subjected to forming, can be dried (again) without drying those sections that will undergo shaping for forming the pod. For shaping, a forming unit is provided, by which the pod element (or of the pod body or of at least a part of the pod) can be formed from a moistened section of the sheet.

This configuration of the manufacturing system is beneficial for avoiding breaches of the pod integrity leading back to either the forming or the moistening process because the sheet can be provided with localized dry sections (e.g. for sealing or handling) as well as moistened sections (for shaping), thus making two contradictory states of the sheet compliant with each other. This is because means for facilitating localized and controlled drying are provided, which can be tailored (e.g. in physical extent, duration, and/or intensity) to the respective application (e.g. size and position of dry patches, sheet material used). Thereby, connection areas for sealing the pod closed can be provided without curls, and material resilience for transferring the sheet can be maintained throughout the process. At the same time, forming the pod is still done with a moistened sheet because only localized drying is performed in the system. In addition, the system of the invention facilitates continuous manufacturing, thereby leading to high output rates, as operations can be performed sequentially and without interruptions.

Thus, the system of the present invention overcomes the disadvantages of the prior art.

According to a preferred embodiment, the handling unit may comprise (one or more) clamping elements. Preferably, the clamping elements may be configured to clamp the sheet at the opposite (with respect to the transfer direction) lateral side edge sections of the sheet. Alternatively or additionally, the clamping elements may be movable along the transfer direction. Preferably, the clamping elements may be configured to clamp the sheet at the opposite lateral side edge sections to allow transferring the clamped sheet through the system along the transfer direction.

Therein, the expression “clamping element” may be understood, for example, as element for fixing, attaching, compressing, and/or holding the sheet (preferably between two opposite elements, components, structures, and/or parts).

Thereby, it is possible to transport the sheet continuously through the system and to hold the sheet under tension along the longitudinal extension of the sheet. Thereby, manufacturing is facilitated in a particular advantageous manner.

According to a preferred embodiment, the lateral drying unit may be arranged to dry the opposite lateral side edge sections of the moistened sheet, while keeping at least the part to be shaped moistened, before or during clamping by the clamping elements. Preferably, the lateral drying unit may be provided between a feeding section for feeding the sheet into the system, and the clamping elements.

Thereby, it can be ensured that the sheet is clamped (only) once the moisture contained inside the sheet has been removed or reduced by the drying unit(s).

According to a further preferred embodiment, the lateral drying unit may comprise drying components, such as hot-air blowers and/or heating elements. For instance, the heating elements may be configured for contact drying or contactless drying (e.g. infrared (IR) or ultraviolet (UV) radiation, e.g. emitted by IR driers or UV driers). Preferably, the lateral drying unit may be integral with the clamping elements. For example, the clamping elements may comprise the heating elements.

Therein, the expression “contact drying” may be understood, for example, as a drying process, in which the element to be dried may be in contact with heated surfaces (so that energy required for drying can be transported into the material by conduction).

Thereby, it can be ensured that drying is performed localized and within a specified time. For instance, rapid evaporation of moisture, which may be required for some sheet materials to remain in its flat sheep and without wrinkles even after moistening, can be performed with the above drying components. Therein, it is particularly advantageous that drying parameters, such as flow rate and temperature of drying medium, and/or distance of the drying element from the sheet, can be conveniently and accurately regulated with the above drying components. Preferably, the drying components may be configured for rapid drying, for example 0.1 s. More preferred, the drying components may preferably be configured in accordance with one or more of the following drying parameters: drying temperature, speed and/or volume of air flow, direction of the air flow.

For instance, drying may be performed within a “drying time span” between 0.5 s and 20 s (e.g. lasting from start to reaching a defined (reduced) moisture level. The drying time span may depend on the thickness of the sheet, the type of sheet material used, and/or the moisture level (level of humidification) at the beginning of the drying process. Preferably, the transfer speed of the sheet may be between 1 cm/s to 100 cm/s.

Therein, the expression “level of humidity” (moisture level) may be understood, for example, as a numerical quantification of a (primarily) liquid substance (or moisture, and/or humidity) contained inside the sheet material. For example, it is conceivable that the level of humidity may be an indication of the (liquid and/or gaseous) water content in the paper, and/or a relative humidity of the (paper) sheet material. Therein, water content (or moisture content) may be understood, for example, as the amount of (liquid and/or gaseous) water contained in a solid material (e.g. measured as a weight in Grams). From this, it becomes clear that in this specification, the terms “moisture” and “humidity” may be used interchangeably unless explicitly stated otherwise.

For example, the level of humidity (moisture level) may be expressed as absolute humidity. For instance, the liquid (moistening agent) content in the material could be measured in weight per volume (g/m³). Alternatively or additionally, the level of humidity (moisture level) may be expressed as relative humidity. For instance, the liquid content may be measured as ratio between a measured moistening agent content and the maximum quantity of the liquid content absorbable in the material (e.g. ratio expressed as percentage).

Preferably, the dried sheet may have a maximum (relative) level of moisture or humidity in the range from 2% to 8%, preferably 5%. In comparison, a moistened sheet may have a (relative) level of moisture or humidity in the range from 9% to 40%, preferably 12% to 20%, more preferred 14% to 16%.

More preferred, the drying components may be configured to dry a defined “drying area” between 1 mm 2 and 30 cm² . Preferably, this drying area may be dried within the above defined drying time span. Preferably, the (vertical) “distance between the drying components and the sheet” may be between 1 cm and 50 cm.

Preferably, the “width of each of the lateral side edge sections” may be in the range between 1% and 10%, preferably between 2% and 5% of the width of the sheet (extending between two lateral side edges of the sheet, and/or preferably measured orthogonally to the longitudinal extension of the sheet). For example, the width of the sheet may be the length of a reel, from which the sheet may be provided.

However, these are only examples and not a complete enumeration and the drying parameters may comprise additional other parameters.

According to a preferred embodiment, the humidifying unit may be arranged to moisten only one side of the sheet. Preferably, the humidifying unit may be arranged to moisten only a lower side of the sheet, for instance, if the sheet may be horizontally transferred through the humidifying unit.

By applying the moistening agent on the lower side of the sheet, it can be ensured that the moistening agent sufficiently soaks into the sheet material while excess liquid is automatically drained by being drawn back out of the material by gravity. Thereby, local variations in the moisture concentration due to the moistening process can be reduced.

According to a further preferred embodiment, the humidifying unit may comprise an immersion unit for immersing the at least one side of the sheet in the moistening agent. Alternatively or additionally, the humidifying unit may comprise a spraying unit for spraying the moistening agent on the at least one side of the sheet. Alternatively or additionally, the humidifying unit may comprise a (cold) steam unit for applying the moistening agent onto the at least one side of the sheet. Alternatively or additionally, the humidifying unit may comprise a roll transfer unit for transferring the moistening agent from a reservoir onto the at least one side of the sheet. For this, one or two rollers may be provided to transfer the liquid onto the sheet, for example. In each of the above configurations, the moistening agent may be provided in a liquid and/or gaseous state.

Thereby, the moistening agent can be applied in various ways onto the sheet material.

According to a further preferred embodiment, the at least one shaping line may further comprise at least one humidity sensor for (visually) sensing the level of humidity of the moistened sheet. Preferably, the humidity sensor may be configured and/or arranged to sense the level of humidity at the at least one side of the sheet. For instance, the at least one humidity sensor may be positioned downstream of the humidifying unit and/or upstream of the forming unit with respect to the transfer direction. For instance, humidity sensor may emit light in the visible spectrum and measure the reflectance of this radiation to determine the level of humidity.

Thereby, it is possible to determine the quantity, location and extent of the moistening agent inside the sheet with high accuracy and sampling speed. This allows adapting the moistening process in the humidifying unit. Accordingly, the structural integrity and shelf-life of the produced pod can be improved and ensured.

According to a preferred embodiment, the at least one shaping line may further comprise a pre-drying unit for drying the sheet before reaching the forming unit. Preferably, the pre-drying unit may be configured and/or arranged for drying at least a part of the sheet, which part may be preferably on the at least one side.

Thereby, it is possible to reduce the level of moisture contained in the moistened section of the sheet before reaching the forming unit. Therein, a control of the pre-drying unit may be adapted based on the results of a measurement of the humidity sensor so that the moistened section of the sheet can be shaped in the forming unit having an optimal moisture level.

According to a preferred embodiment, the system or the at least one shaping line may further comprise a final drying unit for drying the pod element. According to a further preferred embodiment, the system (or the at least one shaping line) may further comprise a filling unit for placing an amount of a brewing material into the pod cavity of the pod element. Therein, the filling unit may be preferably arranged downstream of the final drying unit with respect to the transfer direction.

Therein, the brewing material may be any substance, such as any type of (solid, liquid, at least partially soluble and/or percolate-able) matter of a particular or definite chemical constitution. Examples for such substances may be roasted ground coffee, instant coffee, tealeaves, syrup concentrate, fruit extract concentrate, a chocolate product, dehydrated edible substances like culinary lyophilized bouillons, and/or combinations thereof.

Thereby, the pod element can be dried before reaching the filling unit so that the pod is filled with the brewing material in a dry state, which is beneficial for the pod shelf-life.

According to a preferred embodiment, the system (or the at least one shaping line) may further comprise a joining unit for joining a closing element to the pod element to close the pod cavity (preferably around the amount of said brewing material). Preferably, the closing element may be a lid. Alternatively, the closing element may be another one of the pod elements. Therein, the pod elements may be joined such that their cavities together form a closed pod cavity. In addition, the system may comprise two of the shaping lines, each for forming a pod element, and the joining unit for joining the two pod elements to form the pod cavity.

Thereby, it is possible to provide a physical (and preferably sealing) connection between the pod element and the respective closing element. The connection may be achieved by heat sealing or ultrasonic sealing. Accordingly, it is possible to provide a gas tight enclosure or encapsulation of the brewing material inside the pod cavity. Thereby, the integrity and shelf-life of the pod can be ensured.

According to a further preferred embodiment, the sheet may be an endless sheet. The endless sheet may be provided from a reel. For this, the system (or more specifically: the handling unit) may preferably further comprise a conveying unit for unrolling the sheet. For example, the sheet may longitudinally extend in a continuous manner. Furthermore, the sheet may preferably be suitable for being connected with other such sheets at an end section to form a seemingly “endless” sheet in the manufacturing process.

Thereby, the sheet can be provided in a manner particularly suitable for industrial manufacturing. In particular, sequential and continuous processing can be improved.

According to a preferred embodiment, the sheet may have gas barrier properties.

Therein, a gas barrier may be understood, for example, as the ability of a material to reduce or eliminate gaseous substances passing through the sheet (material). For instance, the sheet may have an oxygen barrier with an oxygen transmission rate (OTR) below 5 cm³/m²/day. Therein, the OTR may be a measure of the amount of oxygen gas that passes through a substance over a defined period. For example, OTR may be measured using known methods specified in industrial standards, such as DIN 53380-3, ASTM D1434 or ISO 2872.

The sheet may have a single-layered structure, which may be made of a cellulose-based material having the gas barrier properties. Alternatively, the sheet may have a multi-layered structure, comprising a paper layer and a barrier layer. Therein, the paper layer may be made of a cellulose-based material. Preferably, the paper layer may form the at least one side, and/or the side forming the lower side of the sheet. The barrier layer may have the gas barrier properties.

By providing the sheet with a gas barrier, the shelf-life of the pod can be improved.

A further aspect of the present invention relates to a method for manufacturing a compostable pod for brewing products. The method comprises the step of transferring a sheet, which is made of a biodegradable cellulose-based material and which preferably may have gas barrier properties, along a transfer direction through the system. At least one side of said sheet is moistened with a moistening agent. A part of the moistened sheet is shaped into a three-dimensional shape to form a pod element defining a pod cavity. Therein, said part is located between opposite, with respect to the transfer direction, lateral side edge sections of the sheet. Before shaping the part of the moistened sheet, the method also comprises the step of drying the opposite lateral side edge sections of the moistened sheet, while keeping at least the part to be shaped moistened. The formed pod element may (then) be (filled and) dried.

All of the definitions and effects described above for the system are equally applicable to the method of this invention. The system is suitable for performing said method.

With the above configuration of the method, it is possible to provide a compostable pod from a sheet material, the pod having a high and reliable structural integrity and shelf-life. This is possible because the method allows reducing the liquid content in the sheet at areas relevant for the integrity of the finalized pod and for transporting the sheet.

According to a preferred embodiment, the method may further comprise the step of clamping the sheet at the lateral side edge sections to preferably transfer the clamped sheet along the transfer direction. Therein, clamping may take place after or during drying the opposite lateral side edge sections. Alternatively or additionally, clamping may take place during shaping the part of the moistened sheet. The step of transferring the sheet may be a process of transferring the clamped sheet along the transfer direction.

Thereby, it is possible to provide an efficient and reliable transfer of the sheet material through the shaping line. In addition, the sheet material can be handled with sufficient care and strength so that manufacturing of the pod can be improved.

According to a further preferred embodiment, the method may further comprise the step of placing an amount of a brewing material into the pod cavity of the pod element. According to a preferred embodiment, the method may further comprise a joining step, in which a closing element may be joined to the pod element to close the pod cavity. The step of joining may preferably comprise joining a lid as the closing element, or joining another one of the pod elements as the closing element. In the latter, the pod elements may preferably be joined such that their cavities together form a closed pod cavity.

Thereby, it is possible to provide a pod with a beverage ingredient and seal the pod from the outside. Thus, the pod can be provided with a prolonged shelf-life.

### BRIEF DESCRIPTION OF DRAWINGS

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

FIG. 1 shows a schematic side view of a manufacturing system with a shaping line according to an embodiment of the invention.

FIG. 2 shows a schematic sectional side view of a pod manufactured with the system and method according to a further embodiment of the invention.

FIG. 3 shows a schematic sectional side view of a pod manufactured with the system and method according to a further embodiment of the invention.

### DETAILED DESCRIPTION

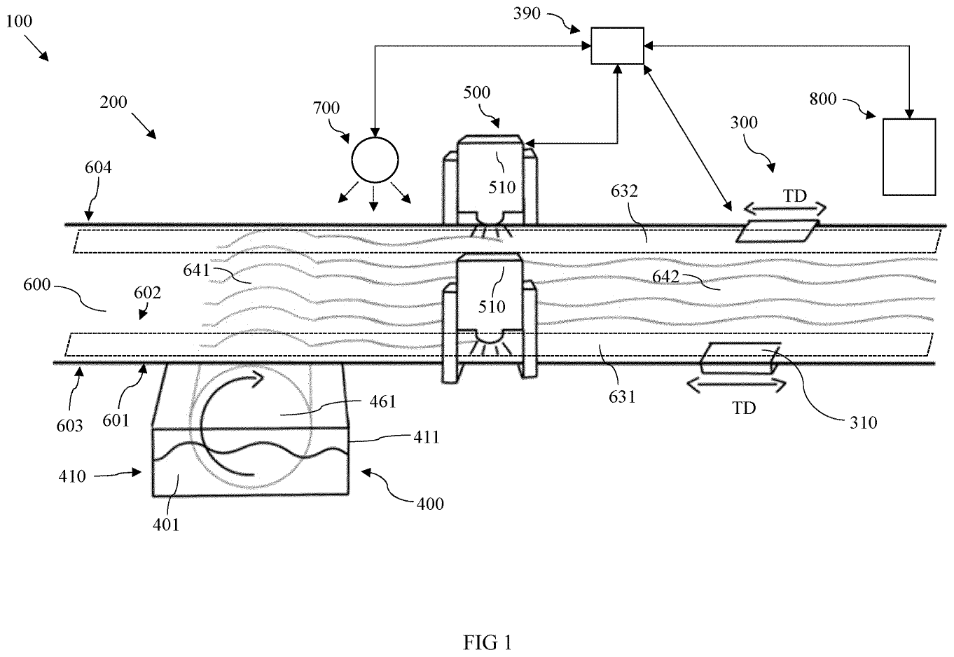

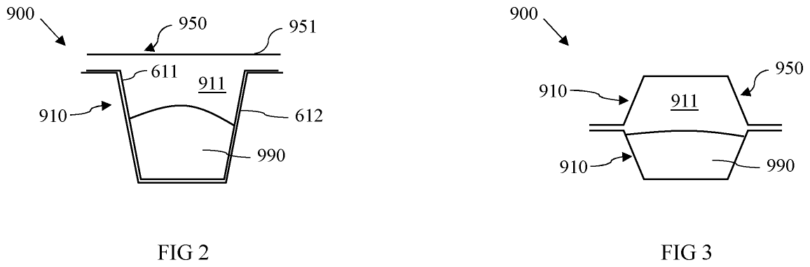

FIG. 1 shows different aspects of an embodiment of the system 100 and method for manufacturing a compostable pod 900 for brewing products according to the invention. FIGS. 2 and 3 show aspects of different embodiments of the compostable pod 900 manufactured with the system 100 and the method according to the present invention.

The system 100 is configured for manufacturing a compostable pod 900 from a sheet 600. FIG. 1 shows the system 100 and some of its components exemplarily. FIGS. 2 and 3 show examples of the pod 900 producible with the system 100.

The sheet 600 is made of a biodegradable cellulose-based material. For example, the cellulose-based material may comprise cellulosic fibres, paper, paperboard, a cellulosic pulp for being moulded, a cellulose nanofibres sheet or film, airlaid cellulose and/or delignified wood. The material of the sheet 600 may provide a barrier against moisture and/or gas. For this, the sheet 600 may have, for example, a single-layered structure of cellulose-based material, the layer being sufficiently thick or composed to provide the gas barrier properties. FIGS. 1 and 3 exemplarily illustrate the use of the sheet 600 having a single layer. Alternatively, the sheet 600 may have, for example, a multi-layered structure with a paper layer 611 made of a cellulose-based material, and a barrier layer 612 with the gas barrier properties. The barrier layer 612 may be provided on the inside or the outside of the pod 900. The use of such material configuration of the sheet 600 is exemplarily shown in FIG. 2.

For industrially manufacturing the pod 900, the sheet 600 may be provided as an endless sheet, for example. This type of sheet 600 may be provided from a reel and the system 100 may comprise a conveying unit for unrolling the sheet 600 from said reel and for introducing the sheet 600 into the system 100 (not illustrated). However, it is also conceivable to provide the sheet 600 as an individual blank sheet. Preferably, the sheet 600 may have a thickness between 10 micrometres and 5 mm, more preferably between 50 and 800 micrometres, even more preferably between 100 and 500 micrometres. More preferred, the sheet 600 may extend longitudinally between two opposite side edges 603, 604. Thus, the sheet 600 may extend laterally between the two side edges 603, 604. The sheet 600 may have an upper side 602 and an opposite lower side 601 (e.g. directional references for the sheet 600 being transported horizontally). FIG. 1 shows this exemplarily.

The system 100 comprises at least one shaping line 200. FIG. 1 exemplarily illustrates an embodiment of the shaping line 200. For instance, the shaping line 200 may comprise a series of stations each providing a functionality required for manufacturing the pod 900. For example, a section of the sheet 600 may pass each of the stations in sequential order. The system 100 may comprise one or more of the shaping line 200.

The shaping line 200 comprises a handling unit 300 for transferring the sheet 600 along a transfer direction TD through the system 100. FIG. 1 shows this exemplarily.

For example, the handling unit 300 may comprise handling elements, such as clamping elements 310. The clamping elements 310 may be configured to clamp the sheet 600 at (with respect to the transfer direction TD) opposite lateral side edge sections 631, 632 of the sheet 600. FIG. 1 shows this exemplarily. For instance, each of the lateral side edge sections 631, 632 may be a continuous (relatively thin) stripe of the sheet 600, which preferably may extend longitudinally with the side edges 603, 604 of the sheet 600.

The clamping elements 310 may be provided movable along the transfer direction TD. By operating the clamping elements 310, the sheet 600 can be clamped at the opposite lateral side edge sections 631, 632 and moved by the clamping elements 310. The so clamped sheet 600 can be transferred through the system 100 along the transfer direction TD.

However, other embodiments of the handling unit 300 are conceivable. For example, the handling unit 300 may be one or two rollers, which may be arranged opposite to each other with respect to the sheet 600, driving the sheet 600 forward by revolving against each other. However, it is also conceivable that the handling unit 300 may be provided as a conveyor band or a pusher. Additional handling elements (e.g. rollers) of the handling unit 300 may be provided at various locations along the transfer direction TD to ensure a reliable transport of the sheet 600 through the system 100. Preferably, the sheet 600 may be linearly moved along the transfer direction TD. The sheet 600 may be transported within the system 100 horizontally (e.g. as shown in FIG. 1), vertically or combinations thereof (not illustrated).

The shaping line 200 further comprises a humidifying unit 400 for moistening at least one side of the sheet 600 with a moistening agent 401. FIG. 1 shows an exemplary embodiment of the humidifying unit 400.

As shown in FIG. 1, the humidifying unit 400 may comprise a roll transfer unit 410 for transferring the moistening agent 401 from a reservoir 411 onto the at least one side of the sheet 600. For instance, the moistening agent 401 may be applied by a roller 461 onto the lower side 601 of the sheet 600, wherein preferably the roller 461 may be at least partially immersed in the moistening agent 401. The roller 461 may then get into contact with the sheet 600 and thereby may bring the moistening agent 401 to the sheet material within a defined section of the sheet 600, which may be referred to as a moistened section 641 of the sheet 600. For instance, the water content in the moistened section may be higher than in the rest of the sheet 600 (e.g. part before the roller 461). Preferably, the humidifying unit 400 may be arranged to moisten only one side of the sheet 600. This is exemplarily illustrated in FIG. 1, where only the lower side 601 of the sheet 600 may be moistened by the humidifying unit 400. Thereby, excess liquid may leave the lower side 601 and may return to the reservoir 411. However, it is also conceivable that the upper side 602 and/or the lower side 601 may be moistened.

Also, other embodiments of the humidifying unit 400 are conceivable, of which the following are briefly discussed: For instance, the humidifying unit 400 may comprise an immersion unit for immersing the at least one side of the sheet 600 in the moistening agent 401. Alternatively or additionally, the humidifying unit 400 may comprise a spraying unit for spraying the moistening agent 401 on the at least one side of the sheet 600. Alternatively or additionally, the humidifying unit 400 may comprise a (cold) steam unit for applying the moistening agent 401 to the at least one side of sheet 600.

Preferably, the sheet 600 may be provided within the system 100 such that the barrier layer 612 may be arranged on the opposite side to the humidifying unit 400, for example, in order to facilitate sufficient uptake of the moistening agent 401 during the moistening process. In other words, the paper layer 611 may preferably be the at least one side and/or the lower side 601 of the sheet 600. However, this is only an example.

The moistening agent 401 may be water, an aqueous-based solution or an alcohol-based solution (such as ethanol, methanol, isopropanol or butanol). The aqueous-based solution may also contain traces of inorganic salts such as sodium, magnesium, calcium and potassium.

The shaping line 200 further comprises a forming unit 800 for shaping a part 642 of the moistened sheet 641 into a three-dimensional shape forming a pod element 910, which defines a pod cavity 911. In FIG. 1, the forming unit 800 is exemplarily indicated.

FIGS. 2 and 3 illustrate exemplarily embodiments of the pod element 910, from which it can be taken, that, for example, the body of the pod 900 may be formed by the pod element 910. As further illustrated exemplarily in FIGS. 2 and 3, the pod element 910 may thereby define the pod interior with the pod cavity 911. For instance, the pod element 910 may be the shaped part 642 of the moistened sheet 641.

The forming unit 800 shapes the part 642, which is located between, with respect to the transfer direction TD, opposite lateral side edge sections 631, 632 of the sheet 600. The forming unit 800 may comprise forming tools, such as a forming die and a movable corresponding stamp for forming the pod element 910 with the pod cavity 911.

The at least one shaping line 200 further comprises a lateral drying unit 500. The lateral drying unit 500 is arranged to dry the opposite lateral side edge sections 631, 632 of the moistened sheet 641, while keeping at least the part 642 to be shaped moistened. This is exemplarily illustrated in FIG. 1. As can be taken from the Figure also, the lateral drying unit 500 may be arranged downstream of the humidifying unit 400 and upstream of the forming unit 800.

For example, the lateral drying unit 500 may comprise drying components, such as hot-air blowers and/or heating elements 510 for drying. FIG. 1 shows this exemplarily. It is also conceivable that the lateral drying unit 500 may be integral with the clamping elements 310 and thus, the clamping elements 310 may comprise the heating elements 510.

In case the clamping elements 310 may be used for transferring the sheet 600 through the system 100, the lateral drying unit 500 may be arranged to dry the opposite lateral side edge sections 631, 632 of the moistened sheet 641 (while keeping at least the part 642 to be shaped moistened) before or during clamping by the clamping elements 310. For this, the lateral drying unit 500 may be provided between a feeding section for feeding the sheet 600 into the system 100 (not shown), and the clamping elements 310.

The shaping line 200 may further comprise a humidity sensor 700 for visually sensing a level of humidity of the moistened sheet 641. Thereby the moistened sheet may be (continuously in time and space) examined by the humidity sensor 700. FIG. 1 illustrates the humidity sensor 700 schematically. Preferably, the humidity sensor 700 may sense the level of humidity at a section of the sheet 600 that may correspond at least partially with the part 642 for shaping in the forming unit 800. Therein, the humidity sensor 700 may sense a section of the sheet 600 at the at least one side of the sheet 600. As illustrated exemplarily in FIG. 1, the at least one humidity sensor 700 may be positioned downstream of the humidifying unit 400 and preferably upstream of the forming unit 800 with respect to the transfer direction TD. Preferably, the humidifying unit 400 and humidity sensor 700 may be arranged on opposite sides with respect to the sheet 600, as exemplarily shown in FIG. 1. For instance, the humidity sensor 700 may comprise an optical instrument, such as a (high resolution) camera, to capture a visual image of at least the moistened section 641 for displaying the level of humidity in the sheet 600.

The shaping line 200 may further comprise a control unit 390 configured to receive values related to the level of humidity sensed by the humidity sensor 700, and to control the humidifying unit 400 as well as the lateral drying unit 500 based on these values. Therein, the control unit 390 may be configured to compare the received values with defined reference values, and to control the humidifying unit 400 based on the comparison between the received values and the defined reference values.

For example, the sheet 600 may be considered at a good moisture level with the level of (relative) moisture or humidity of the sheet material being in the range from 9% to 40%, preferably 12% to 18%, and more preferred 12% to 16%. However, the invention is not limited to these values as they may vary depending on the respective sheet material.

Preferably, the control unit 390 may be configured to control and/or adapt a number of different parameters and components of the shaping line 200. For instance, the control unit 700 may be configured to adapt the travelling speed of the sheet 600, the composition of the moistening agent 401, the travelling speed of the clamping elements 310, and/or the temperature of the forming tools in the forming unit 800. The control unit 390 may preferably be connected with all of the elements of the shaping line 200. The information link (connection) between the respective components is exemplarily illustrated by arrows in FIG. 1 for the handling unit 300, the forming unit 800, the lateral drying unit 500 and the humidity sensor 700. However, this is also applicable to the humidifying unit 400 and/or other components described in the following:

For instance, the system 100 may further comprise a pre-drying unit for drying the sheet 600 before reaching the forming unit 800. Preferably, at least the moistened part 641 of the sheet 600 may be dried by the pre-drying unit. Alternatively or additionally, the system 100 may further comprise a final drying unit for drying the pod element 910. Alternatively or additionally, the system 100 may further comprise a filling unit for placing an amount of a brewing material 990 into the pod cavity 911 of the pod element 910. Therein, the filling unit may be arranged downstream of the final drying unit with respect to the transfer direction TD, for instance. However, it is also conceivable that the filling unit may be part of the forming unit 800. Alternatively or additionally, the system 100 may comprise a joining unit for joining a closing element 950 to the pod element 910 to close the pod cavity 911 around the amount of brewing material 990.

FIGS. 2 and 3 show different examples of embodiments of the closing element 950. For instance, the closing element 950 may be a lid 951, such as exemplarily shown in FIG. 2. Alternatively, the closing element 950 may be another one of the pod elements 910, wherein preferably the pod elements 910, 910 may be joined such that their cavities 911 together form a closed pod cavity 911. For this, it is conceivable that the system 100 may be provided with two shaping lines 200, each for forming a said pod element 910, and may be additionally provided with said joining unit for joining the two pod elements 910, 910.

A further aspect of the invention relates to a method for manufacturing a compostable pod, such as the pod 900 described above. FIGS. 1 to 3 illustrate steps of the method.

For instance, in the method, a sheet, which is made of a biodegradable cellulose-based material and preferably may have gas barrier properties, such as the above described sheet 600, is transferred along the transfer direction TD through the system 100. FIG. 1 shows this exemplarily.

Therein, preferably the method may comprise the step of clamping the sheet 600 at the lateral side edge sections of the sheet 600 to transfer the clamped sheet 600 along the transfer direction TD.

At least one side of said sheet 600 is moistened with a moistening agent, such as the above described moistening agent 401. FIG. 1 shows this exemplarily on the example of the humidifying unit 400 being the roll transfer unit 410.

A level of humidity of at least a section of the moistened sheet 600, such as the moistened section 640, may be visually sensed so that values related to the sensed level of humidity can be received. FIG. 1 shows this exemplarily through the humidity sensor 700 emitting out a light for measuring the moisture level of at least the moistened section 641.

A part 642 of the moistened sheet 641 is shaped into a three-dimensional shape to form a pod element defining a pod cavity, such as the above-described pod element 910 with the pod cavity 911. Therein, the part 642 is located, with respect to the transfer direction TD, between opposite lateral side edge sections 631, 632 of the sheet 600. FIG. 1 illustrates the position and geometry of the part 642 exemplarily. FIGS. 2 and 3 show possible results of the forming (shaping) step exemplarily.

It is conceivable to dry the pod element 910 after the shaping. However, the pod element 910 may be dried at various other stages throughout the manufacturing process.

The process (step) of moistening of the at least one side of the sheet 600 may be controlled based on the values acquired in the visually sensing step. For this, the control unit 390 may be used, for example. The control unit 390 may be configured for controlling and/or providing the process steps of the method.

The opposite lateral side edge sections 631, 632 of the moistened sheet 641 are dried, while keeping at least the part 642 to be shaped moistened, before shaping the part 642 of the moistened sheet 641. FIG. 1 illustrates this exemplarily by the lateral drying unit 500, which may be configured to blow hot air or radiation onto the moistened sheet 641 to dry the lateral side edge section 631, 632 without drying the part 641 to be formed.

Preferably, the step of transferring may mean transferring the clamped sheet 600 along the transfer direction TD. Therein, clamping may preferably take place after or during drying of the opposite lateral side edge sections 631, 632. Alternatively or additionally, clamping may take place during shaping the part 642 of the moistened sheet 641.

The method may comprise the step of placing an amount of a brewing material, such as the above described brewing material 990, into the cavity 911 of the pod element 910. FIGS. 2 and 3 show the filled pod exemplarily.

The method may further comprise the step of joining a closing element, such as the above described closing element 950, to the pod element 910 to close the cavity 911. This is exemplarily illustrated in FIGS. 2 and 3. For instance, the step of joining may comprise joining a lid, such as the lid 951, as the closing element 950 to the pod element 910. Alternatively, another one of the pod elements 910 may be joined as the closing element 950. Thereby, the pod elements 910 may be joined such that their cavities 911 together form a (one) pod cavity 911, which is closed.

The invention is not limited by the embodiments as described hereinabove, as long as being covered by the appended claims. All the features of the embodiments described hereinabove can be combined in any possible way and be provided interchangeably.

1: A system for manufacturing a compostable pod for brewing products from a sheet made of a cellulose-based material, the system comprising at least one shaping line, wherein the at least one shaping line comprises:
a handling unit for transferring the sheet along a transfer direction (TD) through the system;
a humidifying unit for moistening at least one side of the sheet with a moistening agent;
a forming unit for shaping a part of the moistened sheet into a three-dimensional shape to form a pod element defining a pod cavity, wherein the part of the sheet that is shaped is located between opposite lateral side edge sections of the sheet, wherein the opposite lateral side edge sections are opposite from each other with respect to the transfer direction (TD); and
a lateral drying unit arranged to dry the opposite lateral side edge sections of the moistened sheet, while keeping at least the part to be shaped moistened, downstream of the humidifying unit and upstream of the forming unit.

2: The system according to claim 1, wherein the handling unit comprises clamping elements, and wherein the clamping elements are configured to clamp the sheet with respect to the transfer direction (TD), at the opposite lateral side edge sections of the sheet.

3: The system according to claim 2, wherein the clamping elements are movable along the transfer direction (TD), and wherein the clamping elements are configured to clamp the sheet, with respect to the transfer direction (TD), at the opposite lateral side edge sections, of the sheet to allow transferring the clamped sheet through the system along the transfer direction (TD).

4: The system according to claim 2, wherein the lateral drying unit is arranged to dry the opposite lateral side edge sections of the moistened sheet while keeping at least the part to be shaped moistened, before or during clamping by the clamping elements.

5: The system according to claim 1, wherein the lateral drying unit comprises hot-air blowers and/or heating elements.

6: The system according to claim 1, wherein the lateral drying unit is provided between a feeding section for feeding the sheet into the system, and the clamping elements.

7: The system according to claim 1, wherein the humidifying unit is arranged to moisten only one side of the sheet.

8: The system according to claim 1, wherein the humidifying unit comprises at least one of
an immersion unit for immersing the at least one side of the sheet in the moistening agent,
a spraying unit for spraying the moistening agent on the at least one side of the sheet,
a steam unit for applying the moistening agent onto the at least one side of the sheet,
a roll transfer unit for transferring the moistening agent from a reservoir onto the at least one side of the sheet.

9: The system according to claim 1, wherein the at least one shaping line further comprises at least one of
a pre-drying unit for drying the sheet before reaching the forming unit,
at least one humidity sensor for sensing the level of humidity of the moistened sheet,
a final drying unit for drying the pod element,
a filling unit for placing an amount of a brewing material into the pod cavity of the pod element,
a joining unit for joining a closing element to the pod element to close the pod cavity.

10: The system according to claim 9, wherein the closing clement is
a lid, or
an additional pod element.

11: The system according to claim 10, wherein the system comprises
two of the shaping lines, each for forming a pod element, and
a joining unit for joining the pod element and the additional pod element to form the pod cavity.

12: The system according to claim 1,
wherein the sheet is an endless sheet, and/or the sheet has gas barrier properties.

13: A method for manufacturing a compostable pod for brewing products, the method comprising:
transferring a sheet made of a biodegradable cellulose-based material along a transfer direction (TD) through the system;
moistening at least one side of said sheet with a moistening agent;
shaping a part of the moistened sheet into a three-dimensional shape to form a pod element defining a pod cavity, wherein the part of the sheet that is shaped is located between opposite lateral side edge sections of the sheet, wherein the opposite lateral side edge sections are opposite from each other with respect to the transfer direction (TD); and
drying the opposite lateral side edge sections of the moistened sheet, while keeping at least the part to be shaped moistened, before shaping the part of the moistened sheet.

14: The method according to claim 13, further comprising:
clamping the sheet at the lateral side edge sections of the sheet.

15: The method according to claim 13, further comprising at least one of:
placing an amount of a brewing material into the pod cavity of the pod element,
joining a closing element to the pod element to close the pod cavity, wherein the step of joining preferably comprises:
joining a lid as the closing element, or
joining another one of the pod elements as the closing element.

16: The system according to claim 2, wherein the lateral drying unit is integral to the clamping elements.

17: The system according to claim 5, wherein the clamping elements comprise the heating elements.

18: The system according to claim 7, wherein the humidifying unit is arranged to moisten only a lower side of the sheet, with the sheet being horizontally transferred through the humidifying unit.

19: The system according to claim 1, wherein the sheet has gas barrier properties and has a form selected from the group consisting of (i) a single-layered structure made of the cellulose-based material, which has the gas barrier properties, and (ii) a multi-layered structure comprising a paper layer made of the cellulose-based material, and the multi-layered structure further comprising a barrier layer having the gas barrier properties.

20: The system according to claim 1, wherein the sheet is biodegradable.
